(19) United States
(12) Patent Application Publication
(10) Pub. No.: US 2024/0281999 A1
(43) Pub. Date: Aug. 22, 2024

(54) INFORMATON PROCESSING APPARATUS, AND INFORMATION PROCESSING METHOD

(71) Applicant: Nippon Telegraph and Telephone Corporation, Tokyo (JP)

(72) Inventors: Shunsuke TAKAMIYA, Musashino-shi, Tokyo (JP); Tomoyuki KANEKIYO, Musashino-shi, Tokyo (JP); Hitoshi SESHIMO, Musashino-shi, Tokyo (JP)

(21) Appl. No.: 18/569,338

(22) PCT Filed: Jun. 21, 2021
(86) PCT No.: PCT/JP2021/023457

§ 371 Date: Dec. 12, 2023

(51) Int. Cl. G06T 7/73; G06F 16/583; G06V 10/44; G06V 40/20

(52) U.S. Cl. CPC G06T 7/73; G06F 16/583; G06V 10/44; G06V 40/20; G06T 2207/20044

(57) ABSTRACT

An information processing apparatus includes an interface configured to acquire a training moving image obtained by photographing a first person performing an action, and a processor configured to generate training skeleton data indicating positions of joints in the first person in time series from the training moving image and to correct the training skeleton data such that a distance between joints in the training skeleton data matches a distance between joints in a second person different from the first person.

### TECHNICAL FIELD

The present invention relates to an information processing apparatus and an information processing method.

### BACKGROUND ART

A technique for identifying a category (form or the like) of an action (pitching or the like) performed by an arbitrary person from data (a moving image or the like) showing the action has been provided. Such a technique includes performing deep learning on the basis of a data set showing an action of each category performed by the person and generating a network for identifying the category of the action.

Conventionally, in order to generate a data set, it is necessary for the person to perform an action in each category.

### CITATION LIST

### Non Patent Literature

[NPL 1] Schroff, et al., “FaceNet: A Unified Embedding for Face Recognition and Clustering,” Proceedings of the IEEE Computer Society Conference on Computer Vision and Pattern Recognition, 2015

### SUMMARY OF INVENTION

### Technical Problem

However, it is difficult for the person to perform an action in each category. Further, it is necessary for an operator to classify data showing an action performed by the person into each category.

In order to solve the aforementioned problem, a technique that makes it possible to effectively generate data for generating an inference model for identifying a category of an action is provided.

### Solution to Problem

In one aspect of the present invention, an information processing apparatus includes an interface configured to acquire a training moving image obtained by photographing a first person performing an action, and a processor configured to generate training skeleton data indicating positions of joints in the first person in time series from the training moving image and to correct the training skeleton data such that a distance between joints in the training skeleton data matches a distance between joints in a second person different from the first person.

### Advantageous Effects of Invention

According to an embodiment, the information processing apparatus can effectively generate data for generating an inference model for identifying a category of an action.

### BRIEF DESCRIPTION OF DRAWINGS

FIG. 1 is a block diagram showing a configuration example of an information processing apparatus according to a first embodiment.

FIG. 2 is a block diagram showing an action example of the information processing apparatus according to the first embodiment.

FIG. 3 is a flowchart showing an action example of the information processing apparatus according to the first embodiment.

FIG. 4 is a flowchart showing an action example of the information processing apparatus according to a second embodiment.

### DESCRIPTION OF EMBODIMENTS

Hereinafter, an embodiment according to the present invention will be described with reference to the drawings.

### First Embodiment

First, a first embodiment will be described.

An information processing apparatus according to an embodiment acquires data (for example, moving images) showing an action (for example, an action such as one in sports, training or dancing). The information processing apparatus identifies a category (for example, a form) of the action on the basis of the data. The information processing apparatus presents the identified category to an operator.

For example, the action whose category is identified by the information processing apparatus is pitching. Further, the category of the action is a form of pitching (for example, over-hand, three-quarter, side-hand, under-hand, or the like) or the like. Further, the category may also relate to the quality of the action.

Configurations of the action and the category are not limited to specific configurations.

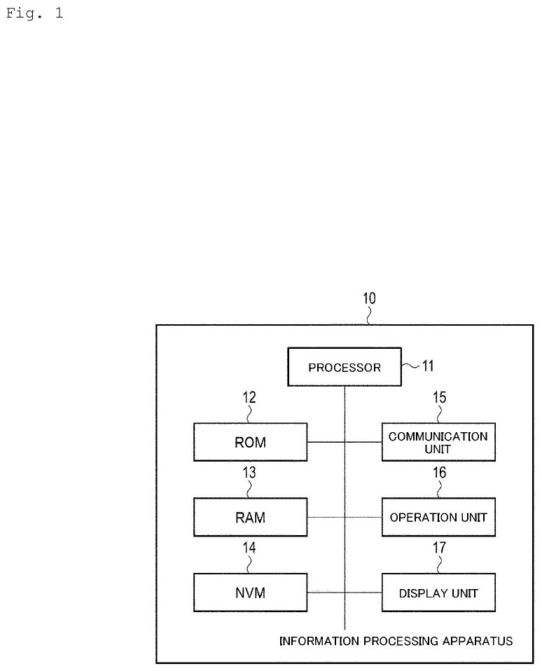

FIG. 1 is a block diagram showing a configuration example of an information processing apparatus 10 (a computer). As shown in FIG. 1, the information processing apparatus 10 includes a processor 11, a ROM 12, a RAM 13, an NVM 14, a communication unit 15, an operation unit 16, a display unit 17, and the like.

The processor 11, the ROM 12, the RAM 13, the NVM 14, the communication unit 15, the operation unit 16, and the display unit 17 are connected to each other via a data bus or the like.

In addition to the components shown in FIG. 1, the information processing apparatus 10 may include a component as necessary, or a specific component may be excluded from the information processing apparatus 10.

The processor 11 has a function of controlling an entire operation of the information processing apparatus 10. The processor 11 may include an internal cache, various interfaces, and the like. The processor 11 realizes various types of processing by executing a program stored in an internal memory, the ROM 12, or the NVM 14 in advance.

Some of the various functions realized by the processor 11 executing the program may be realized by a hardware circuit. In this case, the processor 11 controls the functions that are executed by the hardware circuit.

The ROM 12 is a non-volatile memory in which a control program, control data, and the like are stored in advance. The control program and the control data stored in the ROM 12 are incorporated in advance according to specifications of the information processing apparatus 10.

The RAM 13 is a volatile memory. The RAM 13 temporarily stores data that is being processed by the processor 11. The RAM 13 stores various application programs on the basis of an instruction from the processor 11. Further, the RAM 13 may store data necessary for execution of the application program, execution results of the application program, and the like.

The NVM 14 is a non-volatile memory in which data can be written or rewritten. The NVM 14 is configured of, for example, a hard disk drive (HDD) , a solid state drive (SSD) , or a flash memory. The NVM 14 stores a control program, applications, various types of data, and the like according to operational use of the information processing apparatus 10.

The communication unit 15 is an interface for communication with an external device. For example, the communication unit 15 connects to an external device through a network. For example, the communication unit 15 is an interface that supports wired or wireless local area network (LAN) connection.

Further, the communication unit 15 may be connected to a storage device such as an HDD, an SSD, or a Universal Serial Bus (USB) memory, for example. For example, the communication unit 15 may be an interface that supports USB connection.

The operation unit 16 receives input of various operations from an operator. The operation unit 16 transmits a signal indicating an input operation to the processor 11. The operation unit 16 may be configured as a touch panel.

The display unit 17 displays image data from the processor 11. For example, the display unit 17 is configured as a liquid crystal monitor. When the operation unit 16 is configured as a touch panel, the display unit 17 may be formed integrally with the operation unit 16.

For example, the information processing apparatus 10 is a desktop PC, a notebook PC, a tablet PC, or the like.

Next, functions realized by the information processing apparatus 10 will be described. The functions realized by the information processing apparatus 10 are realized by the processor 11 executing a program stored in the internal memory, the ROM 12, the NVM 14, or the like. For example, the processor 11 realizes the following functions as functions of applications installed in the information processing apparatus 10.

First, the processor 11 has a function of acquiring data showing an action performed by a target person (second person).

The processor 11 acquires a moving image (query moving image) obtained by photographing an action performed by the target person as data showing the action performed by the target person. Here, the query moving image is a moving image of the target person performing one trial (action).

For example, the processor 11 acquires the query moving image through the communication unit 15. The processor 11 may download the query moving image from an external device through the communication unit 15. Further, the processor 11 may acquire the query moving image from an imaging device such as a camera through the communication unit 15.

A method by which the processor 11 acquires the query moving image is not limited to a specific method.

Further, the processor 11 also has a function of generating data (query skeleton data) indicating a position of a joint in time series from the query moving image.

For example, a joint may be a wrist, an arm, a shoulder, a neck, a waist, a hip joint, a knee, an ankle, or the like.

When the query moving image is acquired, the processor 11 identifies the position of each joint of the target person from the query moving image. Here, the processor 11 identifies the position of each joint in a three-dimensional space.

For example, the NVM 14 stores an inference model for identifying the position of each joint from the image in advance. For example, the inference model is a network obtained by deep learning, or the like.

The processor 11 identifies the position of each joint in each frame of the query moving image using an inference model or the like.

When the position of each joint in each frame of the query moving image is identified, the processor 11 generates query skeleton data indicating the position of each joint in time series according to the order of each frame.

Further, the processor 11 also has a function of generating data (training skeleton data) indicating the position of a joint in time series from a training moving image.

The processor 11 acquires the training moving image through a communication unit 15 or the like.

The training moving image is data showing an action of a predetermined category performed by a predetermined person (first person) different from the target person. That is, the training moving image is a moving image obtained by photographing the person performing an action belonging to a predetermined category.

Further, the training moving image is a moving image of the person performing one trial (action).

The processor 11 may acquire a plurality of training moving images as training moving images of a predetermined category. For example, the processor 11 acquires moving images obtained by dividing a moving image of the person who has tried a plurality of times for each trial as training moving images.

The training moving image may be a moving image obtained by photographing a different person for each category or each trial.

Here, the processor 11 acquires a training moving image (data set) of each category F1 . . . Fn. Further, the processor 11 acquires m training moving images for each category.

The NVM 14 may store a training moving image. In this case, the processor 11 acquires the training moving image from the NVM 14 through a predetermined interface or the like.

When the training moving image is acquired, the processor 11 generates training skeleton data from each training moving image. The processor 11 generates one piece of training skeleton data from one training moving image. Here, the processor 11 generates training skeleton data P1 to PM for each category Fi.

Since the method of generating training skeleton data by the processor 11 is the same as the method of generating query skeleton data by the processor 11, description thereof is omitted.

The NVM 14 may store training skeleton data in advance.

Further, the processor 11 has a function of correcting the training skeleton data on the basis of a distance between joints in the target person.

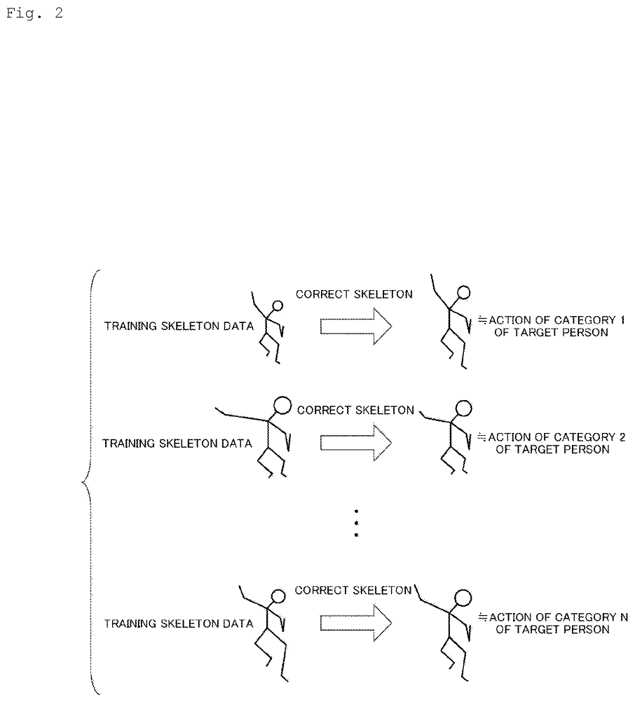

FIG. 2 is a diagram for describing an operation of the processor 11 correcting training skeleton data.

When training skeleton data is generated, the processor 11 acquires a distance between joints in the target person from query skeleton data or the like. The processor 11 may acquire the distance between joints in the target person from the NVM 14 or the like. Further, the processor 11 may acquire the distance between joints in the target person through the communication unit 15.

When the distance between joints in the target person is acquired, the processor 11 corrects training skeleton data such that the distance between joints in the training skeleton data matches (for example, corresponds to) the distance between joints in the target person at each time.

For example, the processor 11 sets one joint for fixing a position in the training skeleton data. When one joint for fixing the position is fixed, the processor 11 corrects the position of each joint in the training skeleton data such that the distance of each joint in the training skeleton data matches the distance between joints in the target person with the joint as a starting point.

As shown in FIG. 2, the processor 11 corrects training skeleton data of each category Fi. That is, the processor 11 corrects each piece of training skeleton data Pi of each category Fi.

According to the above correction, the corrected training skeleton data in the category Fi is approximated to training skeleton data in a case where the target person has performed an action in the category Fi.

The processor 11 may correct the training skeleton data such that the ratio of the distance between joints in the training skeleton data matches (for example, corresponds to) the ratio of the distance between joints in the target person.

Further, the processor has a function of generating an inference model (first category inference model) for identifying a category of an action using the corrected training skeleton data.

The first category inference model identifies a category of an action performed by the target person on the basis of query skeleton data. The first category inference model outputs a feature amount when the query skeleton data or the corrected training skeleton data is input.

Here, the processor 11 generates the first category inference model by deep learning. The processor 11 generates the first category inference model as follows.

First, the processor 11 randomly selects a category Fi. When the category Fi is selected, the processor 11 selects P1, P2, and P3 from corrected training skeleton data P1 to Pm (data set) as follows. The processor 11 randomly selects P1 and P3 from the corrected training skeleton data P1 to Pm of the category Fi. However, P1 and P3 differ from each other.

When P1 and P3 are selected, the processor 11 randomly selects P2 from corrected training skeleton data P1 to Pm of a category Fj (j is different from i).

That is, P1 and P3 are data selected from a data set of the same category Fi, and are called positive data here. Further, P2 is data selected from a data set of the category Fj different from the category Fi, and is called negative data here.

When P1, P2, and P3 are selected, the processor 11 inputs P1, P2, and P3 to the first category inference model to calculate feature amounts f(P1), f(P2), and f(P3) mapped to a feature amount space. Here, f(Pi) indicates a feature amount obtained by inputting Pi to the first category inference model.

Further, a distance between f(P1) and f(P2) in the feature amount space is defined as d1 and a distance between f(P1) and f(P3) in the feature amount space is defined as d2.

When the feature amounts f(P1), f(P2), and f(P3) are calculated, the processor 11 updates the first category inference model such that the distance d2 becomes less than the distance d1. That is, the processor 11 updates parameters of the first category inference model. For example, the processor 11 updates the parameters using triplet loss as a loss function.

The processor 11 repeats the above operation to generate the first category inference model.

According to the above operation, the first category inference model maps feature amounts of corrected training skeleton data belonging to the same category such that they are close, and maps feature amounts of corrected training skeleton data belonging to different categories such that they are far away.

A configuration and a generation method of the first category inference model are not limited to a specific configuration.

Further, the processor 11 has a function of identifying a category of an action performed by the target person on the basis of the first category inference model and query skeleton data.

When the first category inference model is generated, the processor 11 acquires one piece of corrected training skeleton data from the data set of the category Fi. When one piece of corrected training skeleton data is acquired, the processor 11 calculates a feature amount of the query skeleton data and a feature amount of the acquired one piece of corrected training skeleton data using the first category inference model. When both feature amounts are calculated, the processor 11 calculates a distance between both feature amounts. When the distance between both feature amounts is calculated, the processor 11 determines whether the distance between both feature amounts is equal to or less than a predetermined threshold value.

When it is determined that the distance between both feature amounts is equal to or less than the predetermined threshold value, the processor 11 determines that the category of the query skeleton data is the category Fi.

When it is determined that the distance between both feature amounts is not equal to or less than the predetermined threshold value, the processor 11 performs the same operation for the other category Fj.

The processor 11 may calculate the distance for each category as described above. The processor 11 may identify a category corresponding to the shortest distance as a category of the query skeleton data.

A method by which the processor 11 identifies a category according to the first category inference model is not limited to a specific method.

When the category of the query skeleton data is identified, the processor 11 displays the identified category on the display unit 17. For example, the processor 11 displays a message or the like indicating the identified category on the display unit 17.

Next, an operation example of the information processing apparatus 10 will be described.

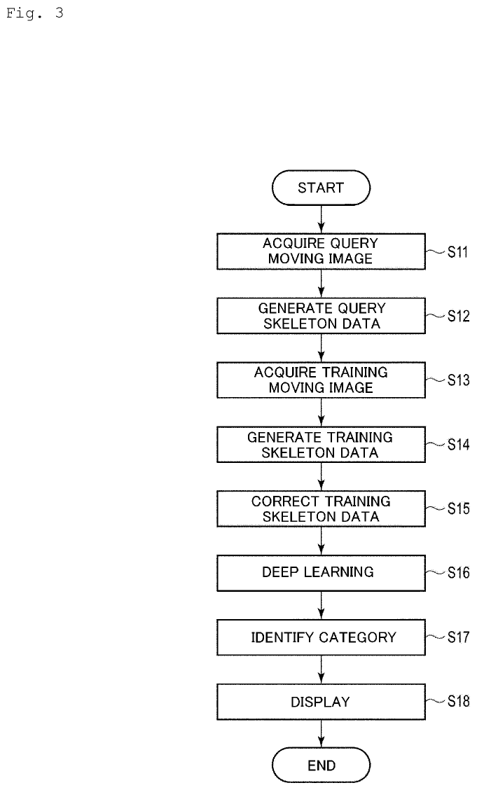

FIG. 3 is a flowchart for describing an operation example of the information processing apparatus 10.

First, the processor 11 of the information processing apparatus 10 acquires a query moving image through the communication unit 15 or the like (S11). When the query moving image is acquired, the processor 11 generates query skeleton data from the query moving image (S12).

When the query skeleton data is generated, the processor 11 acquires a training moving image through the communication unit 15 or the like (S13). When the training moving image is acquired, the processor 11 generates training skeleton data from the training moving image (S14).

When the training skeleton data is generated, the processor 11 corrects the training skeleton data such that the distance of each joint in the training skeleton data matches the distance between joints in the target person (S15).

When the training skeleton data is corrected, the processor 11 generates the first category inference model by performing deep learning on the basis of the corrected training skeleton data (S16). When the first category inference model is generated, the processor 11 identifies a category of an action performed by the target person on the basis of the generated first category inference model and the query skeleton data (S17).

When the category of the action performed by the target person is identified, the processor 11 displays the identified category on the display unit 17 or the like (S18).

When the identified category is displayed on the display unit 17 or the like, the processor 11 ends the operation.

The processor 11 may transmit the corrected training skeleton data to an external device. In this case, the external device may generate the first category inference model and identify the category of the action performed by the target person.

Further, the first category inference model may output information such as a vector indicating a category of an action when query skeleton data is input.

The information processing apparatus configured as described above corrects the training skeleton data such that the distance between joints in the target person matches. Accordingly, the information processing apparatus can generate training skeleton data similar to training skeleton data obtained when the target person has performed an action of each category. Therefore, the information processing apparatus can generate training skeleton data corresponding to the target person without causing the target person to perform an action of each category.

### Second Embodiment

Next, the second embodiment will be described.

An information processing apparatus according to the second embodiment differs from that according to the first embodiment in that a category inference model (second category inference model) for identifying a category of an action is generated from a query moving image. Accordingly, other points are denoted by the same reference numerals and detailed description thereof is omitted.

A configuration of the information processing apparatus 10 according to the second embodiment is the same as that in the first embodiment, and thus description thereof is omitted.

Next, functions realized by the information processing apparatus 10 will be described. The functions realized by the information processing apparatus 10 are realized by the processor 11 executing a program stored in the internal memory, the ROM 12, the NVM 14, or the like. For example, the processor 11 realizes the following functions as functions of applications installed in the information processing apparatus 10.

The information processing apparatus 10 realizes the following functions in addition to the functions realized by the information processing apparatus 10 according to the first embodiment.

The processor 11 has a function of correcting a training moving image on the basis of corrected training skeleton data.

The processor 11 corrects the training moving image such that the distance of each joint in the training moving image matches the distance between joints in the target person. That is, the processor 11 corrects the position of each joint in the training moving image such that the distance between joints matches the distance between joints in the target person.

The processor 11 corrects the training moving image according to a predetermined image processing algorithm or the like. For example, the processor 11 corrects the positions and lengths of the legs, neck, or the like such that the position of each joint becomes a desired position in each frame of the training moving image.

Further, the processor 11 also has a function of generating an inference model (second category inference model) for identifying a category of an action using a corrected training moving image.

The second category inference model identifies a category of an action performed by a target person on the basis of a query moving image. The second category inference model outputs a feature amount when the query moving image or the corrected training moving image is input.

The processor 11 generates the second category inference model by deep learning.

Since the method of generating the second category Inference model by the processor 11 is the same as the method of generating the first category Inference model by the processor 11, description thereof is omitted.

The processor 11 has a function of identifying a category of an action performed by the target person on the basis of the second category inference model and the query moving image.

The method by which the processor 11 identifies a category of an action performed by the target person on the basis of the second category inference model and the query moving image is the same as the method by which the processor 11 identifies a category of an action performed by the target person on the basis of the first category inference model and the query skeleton data, and thus description thereof is omitted.

Next, an operation example of the information processing apparatus 10 will be described.

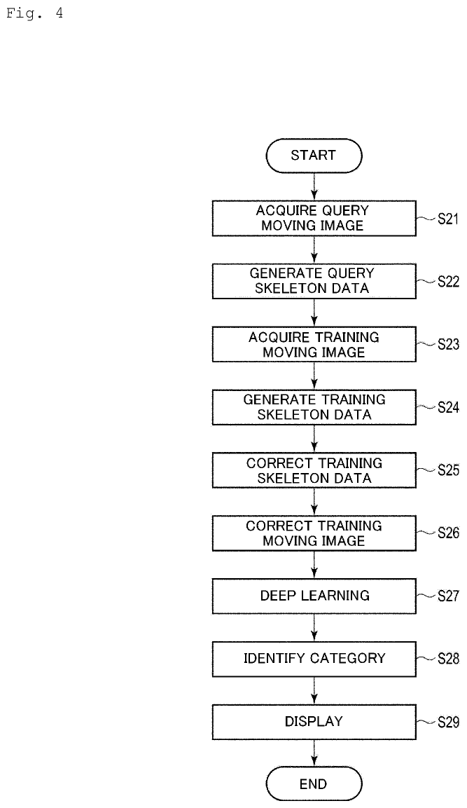

FIG. 4 is a flowchart for describing an operation example of the information processing apparatus 10.

First, the processor 11 of the information processing apparatus 10 acquires a query moving image through the communication unit 15 or the like (S21). When the query moving image is acquired, the processor 11 generates query skeleton data from the query moving image (S22).

When the query skeleton data is generated, the processor 11 acquires a training moving image through the communication unit 15 or the like (S23). When the training moving image is acquired, the processor 11 generates training skeleton data from the training moving image (S24).

When the training skeleton data is generated, the processor 11 corrects the training skeleton data such that the distance of each joint in the training skeleton data matches the distance between joints in the target person (S25).

When the training skeleton data is corrected, the processor 11 corrects the training moving image on the basis of the corrected training skeleton data (S26). When the training moving image is corrected, the processor 11 generates the second category inference model by performing deep learning on the basis of the corrected training moving image (S27).

When the second category inference model is generated, the processor 11 identifies the category of the action performed by the target person on the basis of the generated second category inference model and the query moving image (S28).

When the category of the action performed by the target person is identified, the processor 11 displays the identified category on the display unit 17 or the like (S29).

When the identified category is displayed on the display unit 17 or the like, the processor 11 ends the operation.

The processor 11 may transmit the corrected training moving image to an external device. In this case, the external device may generate the second category inference model and identify the category of the action performed by the target person.

The second category inference model may output information such as a vector indicating a category of an action when a query moving image is input.

Further, the processor 11 may perform predetermined preprocessing on the query moving image and input it to the second category inference model. The processor 11 may perform preprocessing on the corrected training moving image even when generating the second category inference model.

The information processing apparatus configured as described above corrects the training moving image using the corrected training skeleton data. As a result, the information processing apparatus can generate a training moving image similar to a training moving image obtained when the target person performs an action of each category.

The present invention is not limited to the embodiments described above and can variously be modified at an implementation stage within a scope not departing from the gist of the present invention. For example, a type or configuration of the information processing apparatus, a type or configuration of the display device, a procedure and content of information presentation position determination processing, a type of presentation information or a presentation information generation method, and the like can be modified in various manners without departing from the gist of the present invention.

Further, the embodiments may be appropriately selected or combined as much as possible. Further, inventions at various stages are included in the embodiments, and various inventions can be extracted by appropriately combining a plurality of disclosed constituent elements.

### REFERENCE SIGNS LIST

10 Information processing apparatus
11 Processor
12 ROM
13 RAM
14 NVM
15 Communication unit
16 Operation unit
17 Display unit

1. An information processing apparatus comprising:
an interface configured to acquire a training moving image obtained by photographing a first person performing an action; and
a processor configured to generate training skeleton data indicating positions of joints in the first person in time series from the training moving image, and to correct the training skeleton data such that a distance between joints in the training skeleton data matches a distance between joints in a second person different from the first person.

2. The information processing apparatus according to claim 1, wherein the processor is configured
to acquire a query moving image obtained by photographing the second person performing an action through the interface,
to generate query skeleton data indicating positions of joints in the second person in time series from the query moving image,
to generate a first category inference model that identifies a category of an action on the basis of the corrected training skeleton data, and
to identify a category of the action performed by the second person on the basis of the first category inference model and the query skeleton data.

3. The information processing apparatus according to claim 2, wherein the first category inference model is configured to output a feature amount upon input of the query skeleton data, and the processor is configured to generate the first category inference model by deep learning.

4. The information processing apparatus according to claim 1, wherein the processor is configured to correct the training moving image such that a distance between joints in the training moving image matches a distance between joints in the second person on the basis of the corrected training skeleton data.

5. The information processing apparatus according to claim 4, wherein
the processor is configured to acquire a query moving image obtained by photographing the second person performing an action through the interface, to generate a second category inference model that identifies a category of an action on the basis of the corrected training moving image, and to identify a category of the action performed by the second person on the basis of the second category inference model and the query moving image.

6. The information processing apparatus according to claim 5, wherein the second category inference model is configured to output a feature amount upon input of query skeleton data, and the processor is configured to generate the second category inference model by deep learning.

7. The information processing apparatus according to claim 1, wherein the processor is configured to acquire a query moving image obtained by photographing the second person performing an action through the interface, to generate query skeleton data indicating positions of joints in the second person in time series from the query moving image, and to correct the training skeleton data on the basis of the query skeleton data.

8. An information processing method executed by a processor, the method comprising:
acquiring a training moving image obtained by photographing a first person performing an action;
generating training skeleton data indicating positions of joints in the first person in time series from the training moving image; and
correcting the training skeleton data such that a distance between joints in the training skeleton data matches a distance between joints in a second person different from the first person.
